(19) United States
(12) Patent Application Publication
(10) Pub. No.: US 2024/0342992 A1
(43) Pub. Date: Oct. 17, 2024

(54) PRINTING CONSUMABLE CONVEYOR AND 3D PRINTER

(71) Applicant: SHENZHEN ANYCUBIC TECHNOLOGY CO., LTD., Shenzhen (CN)

(72) Inventor: Qiming LIAO, Shenzhen (CN)

(73) Assignee: SHENZHEN ANYCUBIC TECHNOLOGY CO., LTD., Shenzhen (CN)

(21) Appl. No.: 18/757,807

(22) Filed: Jun. 28, 2024

Related U.S. Application Data
(63) Continuation of application No. PCT/CN2022/143859, filed on Dec. 30, 2022.

(30) Foreign Application Priority Data
Dec. 30, 2021 (CN) 202123441454.7

(51) Int. Cl. B29C 64/321; B33Y 30/00

(52) U.S. Cl. CPC B29C 64/321; B33Y 30/00

(57) ABSTRACT

A printing consumable conveyor and a 3D printer are provided. The printing consumable conveyor includes a discharging channel, at least two feeding channels, a pushing apparatus, and a cutting apparatus. The at least two feeding channels are each in communication with the discharging channel, and the pushing apparatus is arranged on the feeding channels. The pushing apparatus is configured to drive a consumable in at least one of the feeding channels to advance into the discharging channel, or to drive a consumable in at least one of the feeding channels to retreat. The cutting apparatus is disposed on the discharging channel, and the cutting apparatus is configured to cut the consumable when the pushing apparatus drives the consumable to retreat to a set position. With the arrangement of the pushing apparatus, at least one of at least two consumables can be driven to be discharged or returned.

### CROSS REFERENCE TO THE RELATED APPLICATIONS

This application is the continuation application of International Application No. PCT/CN2022/143859, filed on Dec. 30, 2022, which is based upon and claims priority to Chinese Patent Application No. 202123441454.7, filed on Dec. 30, 2021, the entire contents of which are incorporated herein by reference.

### TECHNICAL FIELD

The present application relates to the technical field of stereoscopic printing, and in particular, to a printing consumable conveyor and a 3D printer.

### BACKGROUND

A 3-dimension printer (3DP), also referred to as a three-dimensional printing device, is a device of cumulative manufacturing technology, i.e., rapid prototyping technology, and uses adhesive materials such as special wax and powdered metal or plastic on the basis of a digital model file, to manufacture a three-dimensional object by sequentially printing multiple layers of adhesive materials.

Existing 3D printers, especially fused deposition 3D printers, usually use a printing consumable conveyor to convey a consumable. However, the existing printing consumable conveyor has a single function and can only convey a single consumable out, which no longer adapts to the development of 3D printing.

### SUMMARY

Therefore, the technical problem to be solved in the present application is how to provide a printing consumable conveyor and a 3D printer, which can have more functions to adapt to the development of 3D printing.

To solve the above problem, the present application provides a printing consumable conveyor, including: a discharging channel, at least two feeding channels, a pushing apparatus, and a cutting apparatus. The at least two feeding channels are each in communication with the discharging channel, and the pushing apparatus is arranged on the feeding channels. The pushing apparatus is configured to drive a consumable in at least one of the feeding channels to advance into the discharging channel, or to drive a consumable in at least one of the feeding channels to retreat. The cutting apparatus is disposed on the discharging channel, and the cutting apparatus is configured to cut the consumable when the pushing apparatus drives the consumable to retreat to a set position.

In another aspect of the present application, a 3D printer is provided, including a printing consumable conveyor described above.

### Beneficial Effects

In the printing consumable conveyor and the 3D printer according to the embodiments of the present application, with the arrangement of the pushing apparatus, a consumable in at least one of the feeding channels is driven to pass through the discharging channel to advance, or a consumable in at least one of the feeding channels is driven to retreat, that is, at least one of at least two consumables can be driven to be discharged or returned, thus avoiding manual consumable return operations and reducing the manual workload. The pushing apparatus is configured to drive at least one of at least two consumables to move, so that when discharging is performed again, it is possible to switch to a consumable in a different color or made of a different material, and the application range is thus expanded. It is also possible that a consumable of the same type is driven to advance or retreat, so as to implement continuous printing of consumables of the same type, thereby avoiding frequent manual filling after a single consumable is used up, and reducing the manual workload. With the arrangement of the cutting apparatus, an end of a consumable can be cut during consumable return, thereby avoiding the problems of blockage and consumable jamming caused by an irregular consumption end of the consumable. Even if the consumable is used again, the end of the consumable does not have a knot shape formed due to high temperature of a printing head. The consumable does not cause blockage of the printing head or an extruder of the 3D printer, without damaging the 3D printer. In addition, a step of manually cutting the consumption end is omitted, which reduces the manual workload and prevents the blockage and consumable jamming caused by manual negligence.

### BRIEF DESCRIPTION OF THE DRAWINGS

FIG. 1 is a schematic structural perspective view of a printing consumable conveyor according to an embodiment of the present application from a first perspective;

FIG. 2 is a schematic structural perspective view of the printing consumable conveyor according to the embodiment of the present application from a second perspective;

FIG. 3 is a schematic exploded view of the printing consumable conveyor according to the embodiment of the present application;

FIG. 4 is a schematic sectional view of the printing consumable conveyor according to the embodiment of the present application from a first perspective;

FIG. 5 is a schematic sectional view of the printing consumable conveyor according to the embodiment of the present application from a second perspective;

FIG. 6 is a schematic exploded view of a pushing apparatus according to the embodiment of the present application;

FIG. 7 is a schematic sectional view of the pushing apparatus according to the embodiment of the present application in a first state;

FIG. 8 is a schematic sectional view of the pushing apparatus according to the embodiment of the present application in a second state;

FIG. 9 is a schematic sectional view of the pushing apparatus according to the embodiment of the present application in a third state;

FIG. 10 is a schematic exploded view of a pressing apparatus according to the embodiment of the present application;

FIG. 11 is a first schematic structural perspective view of the pressing apparatus and a pressure relief apparatus according to the embodiment of the present application in an exploded state;

FIG. 12 is a second schematic structural perspective view of the pressing apparatus and the pressure relief apparatus according to the embodiment of the present application in the exploded state;

FIG. 13 is a schematic exploded view of a pushing member according to the embodiment of the present application;

FIG. 14 is a side view of the pushing member according to the embodiment of the present application;

FIG. 15 is a schematic exploded view of a cutting apparatus according to the embodiment of the present application;

FIG. 16 is a schematic structural view of a first clamping member of the cutting apparatus according to the embodiment of the present application;

FIG. 17 is a schematic structural view of a rotating member and a cutting member according to the embodiment of the present application before a consumable is cut;

FIG. 18 is a schematic structural view of the cutting apparatus according to the embodiment of the present application before a consumable is cut;

FIG. 19 is a schematic structural view of the rotating member and the cutting member according to the embodiment of the present application after the consumable is cut;

FIG. 20 is a schematic structural view of the cutting apparatus according to the embodiment of the present application after the consumable is cut;

FIG. 21 is a schematic sectional view of the cutting apparatus according to the embodiment of the present application when a consumable passes across a channel pulley;

FIG. 22 is a schematic sectional view of the cutting apparatus according to the embodiment of the present application after a consumption end of the consumable passes across the channel pulley;

FIG. 23 is a schematic sectional view of the printing consumable conveyor according to the embodiment of the present application;

FIG. 24 is a schematic structural perspective view of a base and a cover plate of the printing consumable conveyor according to the embodiment of the present application in an exploded state;

FIG. 25 is a schematic structural view of the base and the cover plate of the printing consumable conveyor according to the embodiment of the present application from a first perspective; and

FIG. 26 is a schematic structural view of the base and the cover plate of the printing consumable conveyor according to the embodiment of the present application from a second perspective.

### LIST OF REFERENCE SIGNS

1. Feeding channel; 2. Discharging channel; 3. Consumable; 41. Power member; 411. Power wheel; 412. First motor; 42. Pressing apparatus; 421. Pressing member; 4211. Pressing roller; 4212. Pressing plate; 422. First elastic member; 43. Pressure relief apparatus; 431. Second elastic member; 432. Pressure relief slider; 44. Pushing member; 441. Cam; 45. Rotating unit; 451. Driving shaft; 46. Feeding roller; 47. Feeding switch; 51. Driving unit; 511. Driving member; 512. Rotating member; 5121. Recessed section; 5122. Smooth section; 52. Cutting member; 53. Clamping unit; 531. First clamping member; 532. Second clamping member; 533. Clamping space; 534. Elastic tensioning unit; 54. Mounting frame; 55. Collection tank; 56. Channel pulley; 57. Cutting switch; 6. Base; 61. Mounting groove; 62. Clearance portion; 7. Cover plate; 71. Mounting hole; 8. Indicator lamp; 9. Printing head.

### DETAILED DESCRIPTION OF THE EMBODIMENTS

In the description of the present application, it should be understood that the orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, and “counterclockwise” is based on the orientation or positional relationship shown in the accompanying drawings, is merely for ease of describing the present application and simplifying the description, and is not intended to indicate or imply that the apparatus or element referred to must have a particular orientation and be constructed and operated in a particular orientation. Therefore, this should not be construed as limiting the present application.

In addition, the terms “first” and “second” are used for descriptive purposes only, and cannot be construed as indicating or implying relative importance or implicitly indicating the number of technical features indicated. Thus, features defined with “first” and “second” may explicitly or implicitly include one or more of the features. In the description of the present application, “a plurality of” means two or more, unless otherwise explicitly and specifically defined. In the present application, it should be noted that, unless otherwise explicitly specified and defined, the terms such as “mounting”, “connecting”, “connection”, and “fixation” should be understood in a broad sense, for example, may be a fixed connection, a detachable connection, or an integrated connection; may be a mechanical connection or an electrical connection; or may be a direct connection, an indirect connection via an intermediate medium, or internal communication between two elements. For those of ordinary skill in the art, specific meanings of the above terms in the present application can be understood according to specific circumstances.

Preferred embodiments of the present application will be described below with reference to the accompanying drawings. It should be understood that the preferred embodiments described herein are merely used for describing and explaining the present application, rather than limiting the present application.

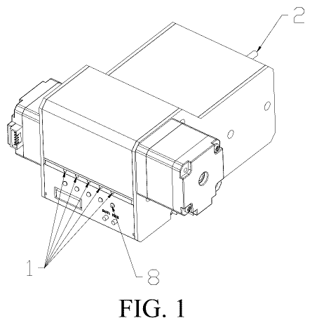

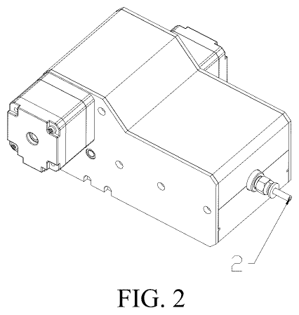

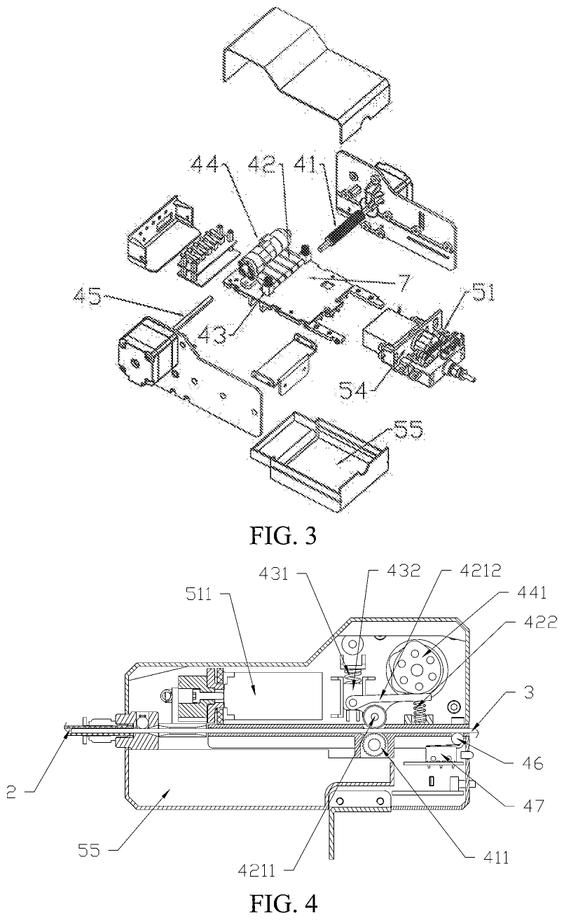

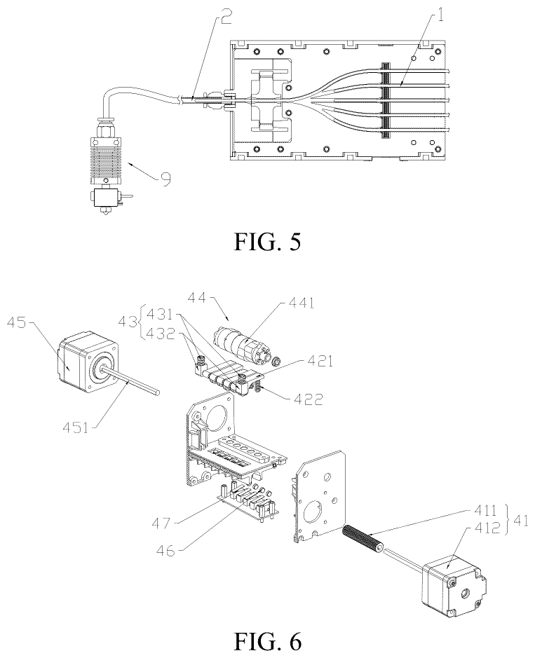

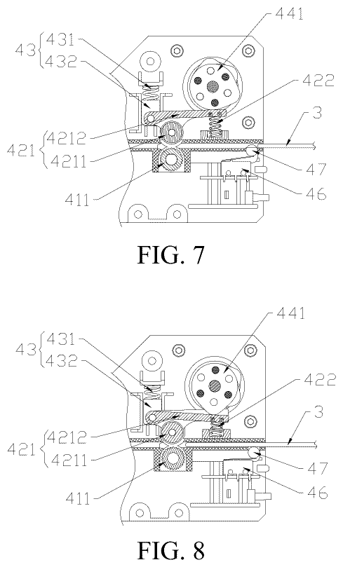

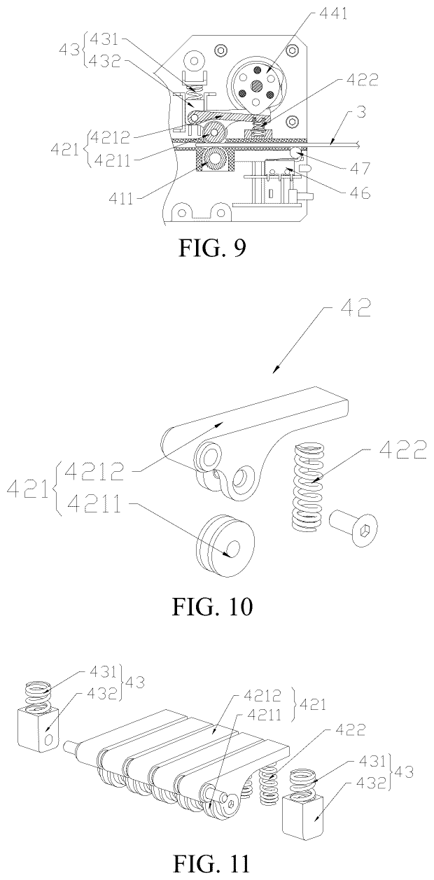

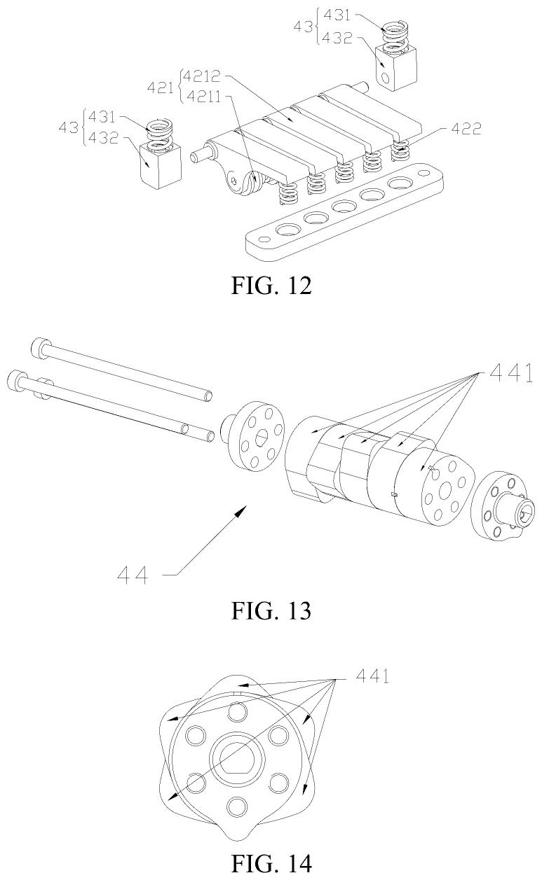

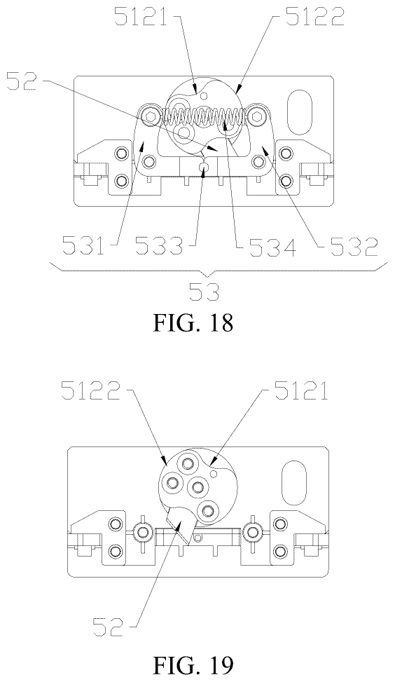

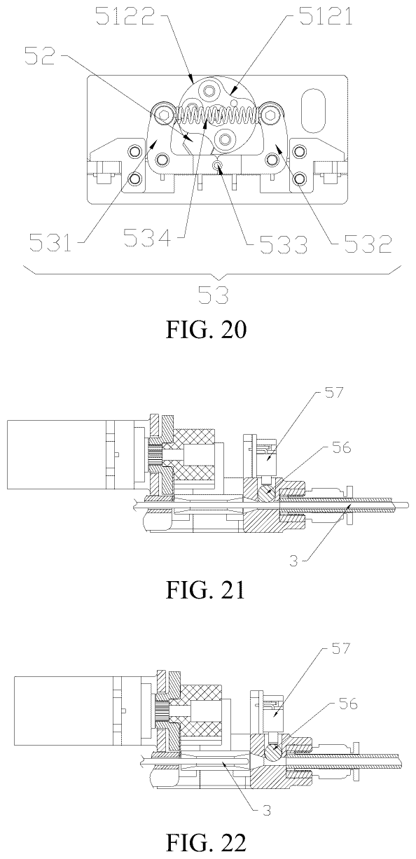

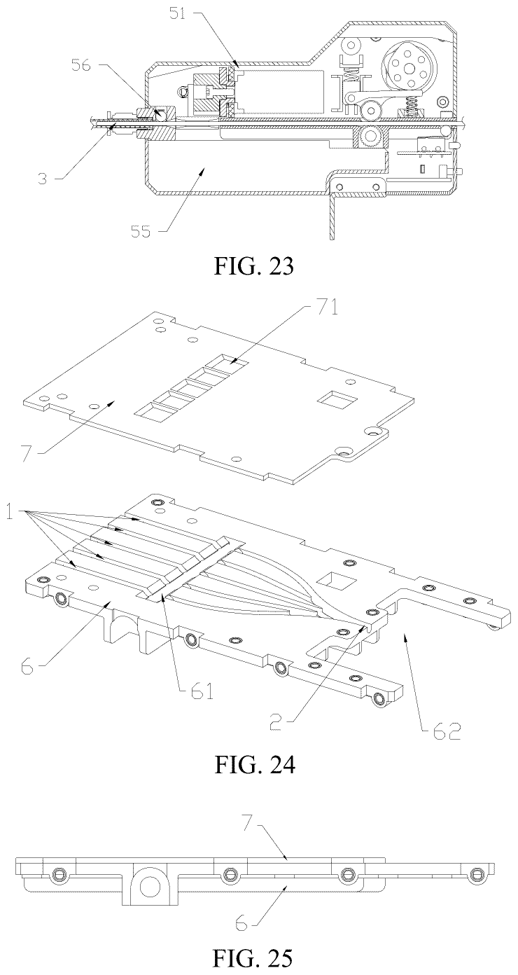

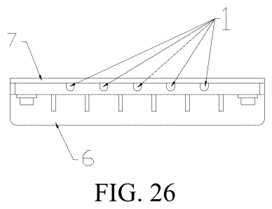

Referring to FIGS. 1 to 26, according to an embodiment of the present application, a printing consumable conveyor includes a discharging channel 2, at least two feeding channels 1, a pushing apparatus, and a cutting apparatus. The at least two feeding channels 1 are each in communication with the discharging channel 2, and the pushing apparatus is arranged on the feeding channels 1. The pushing apparatus is configured to drive a consumable 3 in at least one of the feeding channels 1 to pass through the discharging channel 2 to advance, or to drive a consumable 3 in at least one of the feeding channels 1 to retreat. The cutting apparatus is disposed on the discharging channel 2, and the cutting apparatus is configured to cut the consumable 3 when the pushing apparatus drives the consumable 3 to retreat to a set position.

With the arrangement of the pushing apparatus, a consumable 3 in at least one of the feeding channels 1 is driven to advance into the discharging channel 2 and pass out of same, or a consumable 3 in at least one of the feeding channels 1 is driven to retreat, that is, at least one consumable 3 of at least two consumables 3 can be driven to be discharged or returned, thus avoiding manual consumable return operations and reducing the manual workload. The pushing apparatus is configured to drive at least one of at least two consumables 3 to move, so that when discharging is performed again, it is possible to switch to a consumable 3 in a different color or made of a different material, and the application range is thus expanded. It is also possible that a consumable 3 of the same type is driven to advance or retreat, so as to implement continuous printing of consumables 3 of the same type, thereby avoiding frequent manual filling after a single consumable 3 is used up, and reducing the manual workload. With the arrangement of the cutting apparatus, an end of a consumable 3 can be cut during consumable return, thereby avoiding the problems of blockage and consumable jamming caused by an irregular consumption end of the consumable 3. Even if the consumable 3 is used again, the end of the consumable 3 does not have a knot shape formed by melting and re-solidification due to high temperature of a printing head 9. The consumable 3 does not cause blockage of the printing head 9 or an extruder of the 3D printer, without damaging the 3D printer. In addition, a step of manually cutting the consumption end is omitted, which reduces the manual workload and prevents the blockage and consumable jamming caused by manual negligence.

The feeding channels 1 and the consumables 3 are arranged in a one-to-one correspondence, that is, one feeding channel 1 corresponds to one consumable 3.

All the feeding channels 1 are in communication with the discharging channel 2, and a consumable 3 in each feeding channel 1 can be driven by the pushing apparatus to advance into the discharging channel 2, and can also be driven by the pushing apparatus to retreat into the feeding channel 1 corresponding to the consumable 3.

The set position may be selected on the discharging channel 2, and the cutting apparatus cuts the consumption end of the consumable 3 in the discharging channel 2.

As shown in FIGS. 4 to 14, the pushing apparatus includes a power member 41, a pressing apparatus 42, and a pressure relief apparatus 43. A consumable 3 in each feeding channel 1 is located between the power member 41 and the pressing apparatus 42, and the pressing apparatus 42 is configured to clamp the consumable 3 with the power member 41 under the action of an external force. The power member 41 is configured to drive the clamped consumable 3 to move. The pressure relief apparatus 43 is connected to the pressing apparatus 42, and when a pressure of the pressing apparatus 42 on the consumable 3 is greater than a preset value, the pressure relief apparatus 43 is configured to move the pressing apparatus 42 in a direction away from the power member 41.

The pressure relief apparatus 43 can reduce a force between the pressing apparatus 42 and the power member 41 for clamping the consumable 3, prevent the consumable 3 from being crushed, reduce a force on the power member 41 and the pressing apparatus 42, prolong the service life of the pushing apparatus, and ensure stability of the pushing apparatus.

The structure of the power member 41 is not limited. The power member 41 may include a motor and other apparatuses, and may directly or indirectly drive the consumable 3 to move.

The number of pressing apparatuses 42 is not limited. When a plurality of pressing apparatuses 42 are provided, the number of consumables 3 corresponds to the number of pressing apparatuses 42, and the position of each pressing apparatus 42 corresponds to one feeding channel 1, so as to press the consumable 3 in the corresponding feeding channel 1 downward. In this embodiment, at least two pressing apparatuses 42 may be provided. The pressing apparatuses 42 are arranged corresponding to the consumables 3, the at least two pressing apparatuses 42 are connected to the pressure relief apparatus 43, and the pressing apparatuses 42 can selectively come into contact with the consumable 3, such that the power member 41 and the selected pressing apparatus 42 clamp the consumable 3. In the present application, the pressing apparatuses 42 can selectively come into contact with the consumable 3, that is, one of the pressing apparatuses 42 can be selected to come into contact with the consumable 3 as required. The power member 41 may have two operating states. When the pushing apparatus is in a first operating state, the power member 41 drives a consumable 3 in at least one of the feeding channels 1 to advance into the discharging channel 2. When the pushing apparatus is in a second operating state, the power member 41 drives a consumable 3 in at least one of the feeding channels 1 to retreat. For example, this may be implemented by forward rotation and reverse rotation of the power member 41. Specifically, for example, during switching between a red consumable 3 and a blue consumable 3 for printing, in the pushing apparatus of the present application, two pressing apparatuses 42 are respectively arranged corresponding to the red consumable 3 and the blue consumable 3, and the red consumable 3 is selected to be pushed out for printing as required. When it is necessary to switch, the red consumable 3 is returned, and then the blue consumable 3 is pushed out for printing. In the present application, when a consumable 3 is used up, the pushing apparatus may alternatively drive a consumable 3 of the same type to move, so as to implement continuous printing of consumables 3 of the same type, thereby avoiding frequent manual filling after a single consumable 3 is used up, and reducing the manual workload. For example, two pressing apparatuses 42 both correspond to the consumables 3 of the same type. When one of the consumables 3 is about to be used up, the consumable 3 can be returned and the other consumable 3 can be pushed out to implement continuous printing of the consumables 3 of the same type.

The first operating state is a feeding operating state of the pushing apparatus. In the feeding operating state, the pushing apparatus drives the consumable 3 to be discharged from the printing consumable conveyor to the printing head 9. The second operating state is a consumable return operating state of the pushing apparatus. In the consumable return operating state, the pushing apparatus drives the consumable 3 to return to the printing consumable conveyor.

When a plurality of pressing apparatuses 42 are provided, the plurality of pressing apparatuses 42 are arranged side by side, and consumables 3 are arranged corresponding to the pressing apparatuses 42. Specifically, the consumables and the pressing apparatuses may be arranged in a one-to-one correspondence, and the consumables 3 may be arranged side by side.

The pressing apparatuses 42 may be arranged in parallel to each other, such that the consumables 3 can be fed or returned in the same direction.

The power member 41 provides power for movement of the consumables 3, and the pressing apparatuses 42 clamp the consumables 3 between the power member 41 and the pressing apparatuses 42, and the consumables 3 are driven to move by an action of the power member 41.

Specifically, the power member 41 may include a power wheel 411 and a first motor 412. The power wheel 411 is in contact with the consumables 3, and the consumables 3 are driven to move by rotation of the power wheel 411. The power wheel 411 may be a roller, a roll, etc. The power wheel 411 may alternatively be a plurality of wheels that are separately arranged and rotate synchronously, provided that the power wheel can drive the consumables 3 to move, which is not limited herein. A motor shaft of the first motor 412 is connected to the power wheel 411, and is configured to drive the power wheel 411 to rotate and further drive the consumables 3 to move.

Optionally, the number of power members 41 may be one or at least two, and the number of power members 41 is not limited herein. When at least two power members 41 are provided, one of the power members 41 is arranged corresponding to at least one pressing apparatus 42, and another power member 41 is arranged corresponding to at least one pressing apparatus 42. For example, the power members 41 are arranged in a one-to-one correspondence with the pressing apparatuses 42. In this implementation, one power member 41 is provided, that is, the power member 41 include one power wheel 411 and one first motor 412. A length direction of the power wheel 411 is the same as an arrangement direction of the pressing apparatuses 42, and the clamped consumables 3 can be driven to move by one power wheel 411. The first motor 412 is connected to the power wheel 411 in an axial direction, and is configured to drive the power wheel 411 to rotate forward or backward, so as to drive the consumable 3 to move in a first direction or in a second direction.

The pushing apparatus further includes a pushing member 44. The pushing member 44 can selectively drive a pressing apparatus 42 to move, such that the corresponding pressing apparatus 42 and the power member 41 clamp the consumable 3, or the consumable 3 is separated from the pressing apparatus 42. With the arrangement of the pushing member 44, the required consumable 3 can be selectively clamped, to implement selective printing of a consumable 3 in a different color or made of a different material. That is, as required, the pushing member 44 can selectively come into contact with the pressing apparatuses 42, and drive one of the pressing apparatuses 42 to move toward the power member 41 and clamp the consumable 3.

The pushing member 44 may be arranged on a side of the pressing apparatus 42 away from the power member 41, so as to push the pressing apparatus 42 to move toward the power member 41.

When just entering the feeding operating state, the pushing member 44 drives the pressing apparatus 42 to move toward the power member 41, so as to clamp a corresponding consumable 3 between the power member 41 and the pressing apparatus 42, and thus the power member 41 drives the consumable 3 to move. When in the feeding operating state or the consumable return operating state, the pushing member 44 keeps the pressing apparatus 42 at a position where the consumable 3 is clamped. When exiting the feeding operating state and the consumable return operating state, the pressing apparatus 42 moves away from the consumable 3 along with the pushing member 44, such that the consumable 3 is separated from the power member 41, and thus the power member 41 no longer drives the consumable 3 to move.

The pressing apparatus 42 includes a pressing member 421 and a first elastic member 422, a consumable 3 is located between the power member 41 and the pressing member 421, the first elastic member 422 is arranged on a side of the pressing member 421 close to the power member 41, the pressing member 421 is connected to the pressure relief apparatus 43, and when the pressing member 421 moves toward the power member 41, the first elastic member 422 applies, to the pressing member 421, an elastic force for causing the pressing member to move away from the power member 41. With the arrangement of the pressing member 421, the consumable 3 can be stably pressed. With the arrangement of the first elastic member 422, when the pushing member 44 moves away from the consumable 3, the pressing member 421 can be pushed to keep abutting against the pushing member 44, so as to move away from the consumable 3 along with the pushing member 44, and thus the pressing member 421 is kept separated from the consumable 3 when no consumable 3 is driven to move.

Optionally, the first elastic member 422 is a spring. A first end of the spring is connected to or abuts against a mounting carrier. The mounting carrier is kept stationary relative to the first end of the spring. A second end of the spring is connected to or abuts against a side of the pressing member 421 close to the power member 41. The mounting carrier is not limited herein, provided that the mounting carrier can provide fixed support for the first end of the spring and keep the first end stationary.

The first elastic member 422 may be arranged opposite the pushing member 44. The first elastic member 422 is located on a first side of the pressing member 421, and the pushing member 44 is located on a second side of the pressing member 421.

The pressure relief apparatus 43 may be arranged on a side of the pressing member 421 close to the pushing member 44, or on a side of the pressing member 421 close to the power member 41. In this implementation, the pressure relief apparatus 43 is arranged on the side of the pressing member 421 close to the pushing member 44, that is, the pressure relief apparatus 43 is arranged on a side of the pressing member 421 away from the power member 41, and can make the pressure of the pressing member 421 on the consumable 3 more stable.

The pressure relief apparatus 43 includes a second elastic member 431 and a pressure relief slider 432. The pressure relief slider 432 is connected to the pressing apparatus 42 and the second elastic member 431. The pressure relief slider 432 is arranged on a side of the second elastic member 431 facing the power member 41. The pressure relief slider 432 is limited to move in a direction intersecting with a moving direction of the consumable 3, and the second elastic member 431 applies, to the pressing apparatus 42 by means of the pressure relief slider 432, an elastic force toward a side where the power member 41 is located.

With the arrangement of the second elastic member 431, the preset value may be set based on an elastic coefficient of the second elastic member 431. When the pressure of the pressing apparatus 42 on the consumable 3 is greater than the preset value, the pressing apparatus 42 pushes the pressure relief slider 432 to compress the second elastic member 431, that is, the pressing apparatus 42 moves in a direction away from the consumable 3 to implement pressure relief, so as to prevent an excessive pressure of the pressing apparatus 42 on the consumable 3, which otherwise damages the consumable 3 or the power member 41 and the pressing apparatus 42.

The pressure relief slider 432 is limited to move in a direction intersecting with the moving direction of the consumable 3, so that the pressing apparatus 42 can be stably pressed down, and the preset value can be ensured to be stable, so as to prevent the preset value from changing due to a different moving direction of the pressure relief slider 432.

The pressure relief slider 432 is connected to the pressing member 421 of the pressing apparatus 42, and the pressure relief slider 432 is rotatably arranged on the pressing member 421. Specifically, the pushing apparatus further includes a connecting shaft (not labeled). The connecting shaft runs through the pressing member 421, and two ends of the connecting shaft each may be rotatably connected to one pressure relief slider 432, so that the pressure relief slider 432 can be kept stably connected to the pressing member 421 as the pressure relief slider 432 moves. It can be understood that the connecting shaft may also be rotatably connected to the pressing member 421. The pressure relief slider 432 may be roughly a cuboid, and the second elastic member 431 is connected to an outer wall of the pressure relief slider 432 on a side away from the consumable 3.

The second elastic member 431 may be a spring.

A first end of the second elastic member 431 is fixed to a mounting carrier. The mounting carrier keeps stationary relative to the first end of the second elastic member 431. A second end of the second elastic member 431 is connected to a limiting slider. The mounting carrier is not limited herein, provided that the mounting carrier can provide fixed support for the first end of the second elastic member 431 and keep the first end stationary. Specifically, when the pushing apparatus is applied to the printing consumable conveyor, the mounting carrier may be a housing of the printing consumable conveyor.

The pressure relief slider 432 may be slidably arranged in a slideway of the mounting carrier, and the movement of the pressure relief slider 432 in a direction intersecting with the moving direction of the consumable 3 is restricted by providing the slideway. Specifically, in this implementation, a sliding direction of the pressure relief slider 432 is perpendicular to the moving direction of the consumable 3.

The pressing member 421 includes a pressing roller 4211 and a pressing plate 4212. The pressing roller 4211 is arranged on the pressing plate 4212, the pressing roller 4211 is rotatably connected to the pressing plate 4212, and the pressing roller 4211 is arranged opposite the power member 41. The consumable 3 is located between the power member 41 and the pressing roller 4211, and the pushing member 44 is arranged on a side of the pressing plate 4212 away from the pressing roller 4211.

The pressing plate 4212 includes a first end and a second end. The pushing member 44 and the first elastic member 422 are arranged at the first end, and the pressure relief apparatus 43 is arranged at the second end. The first end of the pressing plate 4212 causes the pressing roller 4211 and the power member 41 to clamp the consumable 3 under the action of an external force, that is, under the action of the pushing member 44. With the arrangement of the pressing roller 4211, rolling friction can be formed between the pressing member 421 and the consumable 3, so that the service life of the pressing member 421 can be prolonged. In addition, it is ensured that the consumable 3 is prevented from being scratched or damaged, and it can also be ensured that the consumable 3 is easier to be driven.

The connecting shaft runs through the pressing plate 4212. One end of the connecting shaft is rotatably connected to the pressure relief slider 432 of one pressure relief apparatus 43, and the other end of the connecting shaft is rotatably connected to the pressure relief slider 432 of another pressure relief apparatus 43. It can be understood that when a plurality of pressing apparatuses 42 are provided, the connecting shaft can pass through the pressing plates 4212 of the plurality of pressing apparatuses 42.

The pressing roller 4211 may be arranged opposite the power member 41 in a direction perpendicular to the consumable 3, so as to ensure that the consumable 3 is clamped. The pushing member 44 can push the pressing plate 4212 toward the consumable 3, and thus the pressing roller 4211 and the power member 41 clamp the consumable 3.

The pressing plate 4212 includes a flat plate section and a protruding section. The limiting slider, the first elastic member 422 and the pushing member 44 are in contact with the flat plate section, and the protruding section is connected to the flat plate section. The protruding section protrudes from the flat plate section toward the power member 41. The pressing roller 4211 is rotatably arranged on the protruding section, to ensure that the pressing roller 4211 can be in good contact with the power member 41 while stably rotating.

Optionally, the pressing roller 4211 may be arranged between the first end and the second end, the pushing member 44 and the first elastic member 422 are arranged at the first end, and the pressure relief apparatus 43 is arranged at the second end, so that two ends of the pressing plate 4212 can be pressed down simultaneously, thereby ensuring uniform distribution of the downward pressure. When the downward pressure is greater than the preset value, the pushing member 44 presses down from the first end while the second end of the pressing plate 4212 further causes the pressure relief apparatus 43 to slide upward, which can stably implement pressure relief and prevent parts and the consumable 3 from being crushed.

The pushing member 44 includes a plurality of cams 441, and the cams 441 are arranged corresponding to the pressing plates 4212. For example, the cams and the pressing plates may be in a one-to-one correspondence. When rotating to a set rotation position, the cams 441 can drive the corresponding pressing plates 4212 to cooperate with the power member 41 to clamp the consumable 3. The pushing apparatus further includes a rotating unit 45. The rotating unit 45 includes a driving shaft 451. The cams 441 are arranged on the driving shaft 451, the cams 441 are arranged in an axial direction of the driving shaft 451 and rotate synchronously, and protrusions of the plurality of cams 441 are sequentially staggered by a preset angle in a rotation direction of the driving shaft 451. The protrusions of the cams 441 are arranged in a staggered manner in a circumferential direction of the driving shaft 451, a consumable 3 can be selectively driven to move, and a suitable consumable 3 can be selected as required. The protrusions of the cams 441 are sequentially staggered by a preset angle in the rotation direction of the driving shaft 451, so that one of the cams 441 can drive the pressing member 421 to press down the consumable 3 each time the driving shaft 451 rotates by a preset angle, and the consumable 3 can be selectively driven to move by controlling the driving shaft 451 to rotate by a multiple of the preset angle. The set rotation position is a position where the cam 441 just comes into contact with a corresponding pressing plate 4212 and starts to drive the corresponding pressing plate 4212 to move toward the consumable 3. The set rotation position may be set by setting the size of the protrusion and the preset angle between adjacent cams 441.

The protrusion is a part of the cam 441 that protrudes outward in the radial direction. When the protrusion comes into contact with the pressing plate 4212, the pressing plate 4212 is driven to move, such that the pressing roller 4211 and the power member 41 press the consumable 3. When the protrusion is separated from the pressing plate 4212, the pressing roller 4211 is separated from the consumable 3. All the cams 441 are coaxially arranged. Seen from an axial direction, the protrusions of the cams 441 are sequentially staggered by a preset angle in the rotation direction of the cams 441.

Optionally, the rotating unit 45 includes a second motor. The driving shaft 451 is coaxially connected to a motor shaft of the second motor, or the driving shaft 451 may be the motor shaft of the second motor, provided that the driving shaft 451 can be rotated, and then drive the cam 441 to rotate.

The driving shaft 451 includes a first end and a second end; and among the plurality of cams 441 on the driving shaft 451, a cam 441 closest to the first end is a first cam, a cam 441 closest to the second end is a second cam, and a minimum angle between the first cam and the second cam in the rotation direction of the driving shaft 451 is greater than the preset angle. A blank area without the protrusions of the cams 441 may be formed in a circumferential direction of the pushing member 44, that is, in a circumferential direction of the driving shaft 451, and the blank area may serve as a starting point or an ending point for the rotation of the pushing member 44. When the blank area faces the pressing plate 4212, the protrusion of each cam 441 does not drive the pressing plate 4212 to a clamping position where a consumable 3 is clamped. In this case, the consumable 3 may be manually placed between the cam 441 and the power member 41.

With a plane perpendicular to a central axis of the driving shaft 451 as a projection plane, a central line of the protrusion of the first cam is defined as a in a projection of the first cam on the projection plane, a central line of the protrusion of the second cam is defined as b in a projection of the second cam on the projection plane, and a minimum included angle formed between a and b is a minimum angle between the first cam and the second cam in the rotation direction of the driving shaft 451. It can be understood that the preset angle is an included angle formed by central lines of two protrusions in projections of adjacent cams 441 on the projection plane.

In this implementation, in an example in which five cams 441 are provided, protrusions of adjacent cams 441 are sequentially staggered by 60° in the rotation direction of the driving shaft 451, that is, the preset angle is 60°. An included angle between the first cam and the second cam in the rotation direction of the driving shaft 451 is 120°. With a blank area formed by the first cam and the second cam in the circumferential direction of the driving shaft 451 as a starting point, the switching between different consumables 3 can be implemented each time the driving shaft 451 rotates by 60°.

The printing consumable conveyor further includes a controller (not shown). The controller controls the pushing apparatus and/or the cutting apparatus. If the controller can control the pushing apparatus, the pushing apparatus is controlled to drive consumables 3 in a preset order. The controller is electrically connected to the rotating unit 45, and the controller may be configured to control the pushing apparatus to drive the consumables 3 to move in sequence according to the preset order. That is, the controller selects a pressing apparatus 42 according to the preset order, so that the selected pressing apparatus 42 comes into contact with the consumable 3, and thus the same printing consumable conveyor can drive the consumables 3 in different colors or made of different materials to print and switch, thereby expanding the application range. A consumable 3 of the same type may alternatively be driven to move, so as to implement continuous printing of consumables 3 of the same type, thereby avoiding frequent manual filling after a single consumable 3 is used up, and reducing the manual workload.

The controller may be a control chip, etc. The controller presets an order in which the consumables 3 are conveyed, that is, a preset order, and controls the driving shaft 451 to rotate according to the preset order, so as to select a pressing apparatus 42 according to the preset order, and drive a corresponding consumable 3 to print by means of the pressing apparatus 42 and the power member 41.

In order to facilitate switching, the consumables 3 to be used may be sequentially arranged based on the preset order. For example, a red consumable 3 is first used for printing, and then a blue consumable 3 is used for printing. The red consumable 3 may be placed at a position corresponding to the leftmost cam 441, and then the blue consumable 3 may be placed at a position corresponding to the second cam 441 on the left. With a preset angle of 60° as an example, the switching between the red consumable 3 and the blue consumable 3 can be implemented by rotating the driving shaft 451 by 60°.

The pushing apparatus may also switch the consumables 3 arranged spaced apart.

Each feeding channel 1 is provided with a feeding roller 46, and a feeding switch 47 is arranged on a side of the feeding roller 46 away from the feeding channel 1. The feeding switch 47 is electrically connected to the controller. When there is a consumable at a position of the feeding channel 1 corresponding to the feeding switch 47, the feeding switch 47 may send a consumable passing signal to the controller.

It is defined that one end of a consumable 3 that first enters the feeding channel 1 is a head end, and as the consumable 3 is conveyed out, the other end that subsequently enters the feeding channel 1 is a tail end. It should be noted that although the head end of the consumable 3 will be consumed and cut, the end that has been consumed or cut is still considered to be the head end.

When the pushing apparatus is in the first operating state, after the tail end of the consumable 3 passes across the feeding roller 46, the feeding roller 46 triggers the feeding switch 47 to be converted from a consumable passing signal to a consumable cutting signal. After receiving the consumable cutting signal, the controller may control the pushing apparatus to enter the second operating state.

When the pushing apparatus is in the second operating state, after the head end of the consumable 3 passes across the feeding roller 46, the feeding roller 46 triggers the feeding switch 47 to be converted from a consumable passing signal to a consumable cutting signal. After receiving the consumable cutting signal, the controller may switch the consumables 3 based on the preset order and then control the pushing apparatus to enter the first operating state again, or control the pushing apparatus to stop operating.

With the arrangement of the feeding roller 46 and the feeding switch 47 and by cooperation with the controller, the switching between the first operating state and the second operating state can be implemented, and thus the switching of consumables 3 in different colors or made of different materials and the continuous printing of consumables 3 of the same type can be implemented. The switching between the first operating state and the second operating state may be implemented immediately or by means of other state combinations, which is not limited in the present application.

Optionally, the feeding roller 46 is located below the consumable 3, and the feeding switch 47 is located below the feeding roller 46. When the consumable 3 passes across the feeding roller 46, the consumable 3 pushes the feeding roller 46 downward, so that the feeding roller 46 touches and presses the feeding switch 47, and thus the feeding switch 47 sends a consumable passing signal. When the pushing apparatus is in the second operating state and after the head end of consumable 3 passes across the feeding roller 46, or when the pushing apparatus is in the first operating state and the tail end passes across the feeding roller 46, the consumable 3 no longer applies a pressure to the feeding roller 46, and the feeding roller 46 no longer applies a pressure to the feeding switch 47, so that the feeding switch 47 is triggered to be converted from a consumable passing signal to a consumable cutting signal.

Optionally, the housing is further provided with indicator lamps 8. The indicator lamps 8 are electrically connected to the controller. The indicator lamps 8 are arranged in a one-to-one correspondence with the feeding channels 1. When a consumable 3 enters a feeding channel 1 and triggers the feeding switch 47 in the feeding channel 1, the controller controls the indicator lamp 8 corresponding to the feeding channel 1 to be lit up.

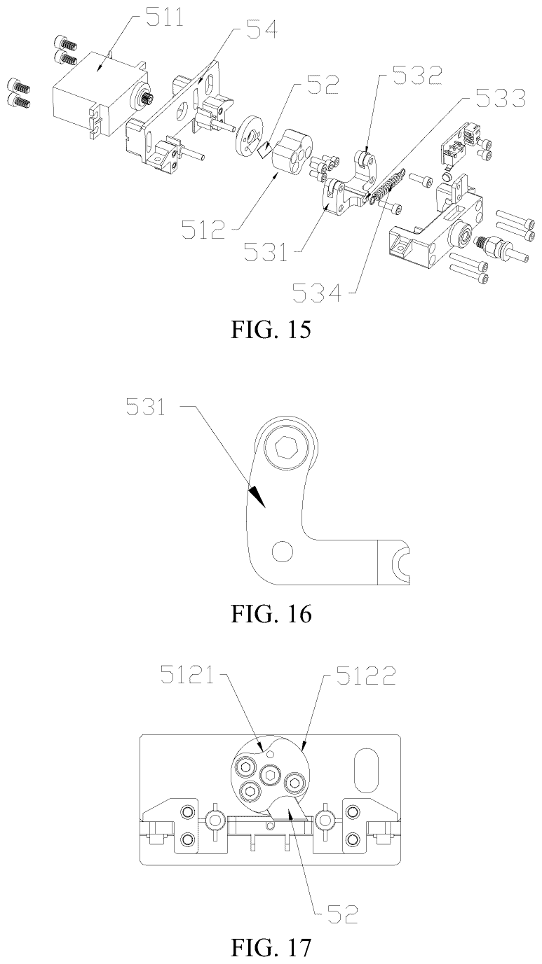

As shown in FIGS. 15 to 23, the cutting apparatus includes a driving unit 51 and a cutting member 52, and the controller is electrically connected to the driving unit 51 to send a control instruction to the driving unit 51. The driving unit 51 is connected to the cutting member 52 to drive the cutting member 52 to move based on the control instruction to cut a consumable 3.

The cutting apparatus can cut an end of a replaced consumable 3, thereby avoiding the problems of blockage and consumable jamming caused by an irregular consumption end of the consumable 3. Even if the consumable 3 is used again, the end of the consumable 3 does not have a knot shape formed due to high temperature of a printing head 9. The consumable 3 does not cause blockage of the printing head 9 or an extruder of the 3D printer, without damaging the 3D printer. In addition, a step of manually cutting the consumption end is omitted, which reduces the manual workload and prevents the blockage and consumable jamming caused by manual negligence.

The driving unit 51 is specifically configured to drive, during replacement of a consumable 3 used by a 3D printer, the cutting member 52 to cut an end of the consumable 3 when the consumable 3 retreats for a preset time or retreats to a preset position.

The specific preset position is not limited, and may be determined based on a sensor, etc. The preset time may be the time taken for the consumable 3 to retreat. After the consumable 3 retreats for the preset time, the consumables 3 stop moving and the consumable 3 is cut. The specific preset time is also not limited, and for example, may be 5 s or 6 s.

The cutting apparatus may further include a clamping unit 53. During cutting of the consumable 3, the driving unit 51 is configured to drive the clamping unit 53 to clamp the consumable 3 and drive the cutting member 52 to act to cut the consumable 3, and after the consumable 3 is cut, the driving unit 51 is configured to drive the clamping unit 53 to release the consumable 3 and drive the cutting member 52 to move away from the consumable 3. The cutting member 52 may be located on one side of the clamping unit 53. The consumable 3 can be clamped by the clamping unit 53, which better facilitates the cutting of the consumable 3 by the cutting member 52.

The consumable 3 can be automatically cut by arranging the driving unit 51 and the cutting member 52. With the arrangement of the clamping unit 53, when the clamping unit 53 releases the consumable 3, the consumption end of the cut consumable 3 can be discharged, thereby avoiding the problems of blockage and consumable jamming caused by an irregular consumption end of the consumable 3, and omitting a step of manually cutting the consumption end, which reduces the manual workload and prevents the blockage and consumable jamming caused by manual negligence.

It can be understood that the driving unit 51 is connected to the cutting member 52 and the clamping unit 53, the driving unit 51 may be connected to the cutting member 52 via other elements, and the driving unit 51 may be connected to the clamping unit 53 via other elements. The driving unit 51 may further include a plurality of driving subunits, with one driving subunit connected to the cutting member 52 and another driving subunit connected to the clamping unit 53.

It can be understood that when the driving unit 51 drives the clamping unit 53 to clamp the consumable 3 and drives the cutting member 52 to act to cut the consumable 3, it is possible to first drive the clamping unit 53 to clamp the consumable 3 and then drive the cutting member 52 to cut the consumable 3, or to drive the clamping unit 53 to clamp the consumable 3 and drive the cutting member 52 to act to cut the consumable 3 simultaneously. When the driving unit 51 drives the clamping unit 53 to release the consumable 3 and drives the cutting member 52 to move away from the consumable 3, it is possible to first drive the clamping unit 53 to release the consumable 3 and then drive the cutting member 52 to move away from the consumable 3, or first drive the cutting member 52 to move away from the consumable 3 and then drive the clamping unit 53 to release the consumable 3, or drive the clamping unit 53 to release the consumable 3 and drive the cutting member 52 to move away from the consumable 3 simultaneously.

One or two driving units 51 may be provided. When one driving unit 51 is provided, the driving unit 51 can drive both the cutting member 52 and the clamping unit 53 to move. When two driving units 51 are provided, one driving unit 51 is connected to the cutting member 52 and is configured to drive the cutting member 52 to move, and the other driving unit 51 is connected to the clamping unit 53 and is configured to drive the clamping unit 53 to move. The number of driving units 51 is not limited in the present application, provided that the driving units can drive the cutting member 52 and the clamping unit 53 to move and make the cutting member 52 and the clamping unit 53 cooperate with each other.

Specifically, in this implementation, the description is given assuming that one driving unit 51 is provided, the driving unit 51 is connected to both the cutting member 52 and the clamping unit 53, and is configured to drive the cutting member 52 and the clamping unit 53 to move synchronously.

Optionally, the cutting member 52 is located on one side of the clamping unit 53, that is, the cutting member 52 is arranged adjacent to the clamping unit 53, and a gap may be provided, to facilitate the cutting of the consumable 3. In addition, the length of the cut consumption end can be shortened to avoid a waste of the consumable 3.

Specifically, in this implementation, it is defined that when the printing consumable conveyor is in a consumable return condition, the moving direction of the consumable 3 in the printing consumable conveyor is a first direction, and the cutting member 52 is located on a first direction side of the clamping unit 53, so that it can be ensured that the consumption end is wholly cut and the cut consumption end is discharged.

The type of the cutting member 52 is not limited. For example, the cutting member 52 may be of a scissors type, or the cutting member 52 may be a cutting knife.

The clamping unit 53 can discharge the consumption end out of a moving path of the consumable 3 after the consumable 3 is cut, so as to avoid blocking the subsequent discharge of a consumable 3.

The driving unit 51 includes a driving member 511 and a rotating member 512. The driving member 511 is connected to the rotating member 512 and is configured to drive the rotating member 512 to rotate. The cutting member 52 is connected to the rotating member 512, such that the cutting member 52 rotates with the rotating member 512, and a blade end of the cutting member 52 protrudes from the rotating member 512 in a radial direction of the rotating member 512.

With the arrangement of the rotating member 512, a mounting position is provided for the cutting member 52, and a running path is provided, so that the blade end of the cutting member 52 protrudes from the rotating member 512 in the radial direction of the rotating member 512, which can ensure that the cutting member 52 effectively cuts the consumable 3. The driving member 511 can stably drive the rotating member 512 to rotate, to provide power for cutting the consumable 3.

The consumable 3 is located on a radial outer side of the rotating member 512, and the length by which the cutting member 52 extends out of the rotating member 512 is set such that the consumable 3 can be completely cut.

The driving member 511 may be a motor, and the rotating member 512 is connected to a motor shaft of the motor. The rotating member 512 is coaxially arranged with the motor shaft to drive the rotating member 512 to rotate about its own central axis through the rotation of the motor shaft. The driving member 511 may alternatively be a servo motor, etc.

Optionally, in an implementation, the cutting member 52 may be fixedly and directly connected to the rotating member 512, such that the rotating member 512 drives the cutting member 52 to rotate. In another implementation, the driving unit 51 further includes a connecting disk, and the cutting member 52 is fixedly arranged on the connecting disk. The connecting disk is sleeved on the motor shaft, and the connecting disk is coaxially arranged with the rotating member 512. The connecting disk may be connected to the rotating member 512, and a part of the cutting member 52 is located between the connecting disk and the rotating member 512. This can enhance the connection stability of the cutting member 52 while ensuring that the rotating member 512 drives the cutting member 52 to rotate. Specifically, the connecting disk is fixedly connected to the rotating member 512 via screws. The cutting member 52 extends radially out of the connecting disk and the rotating member 512.

The printing consumable conveyor includes a housing, and the pushing apparatus and the cutting apparatus may be arranged in the housing. The housing includes a collection tank 55, and an opening of the collection tank 55 is arranged opposite the clamping unit 53. With the arrangement of the collection tank 55, the cut consumption ends can be collected, which facilitates unified recycling and can further prevent the cut consumption ends from affecting the operation of the apparatus.

The collection tank 55 is located directly below the clamping unit 53, and the cut consumption end falling from a clamping space 533 falls into the collection tank 55 by means of its own gravity.

The housing includes a first part and a second part. The first part is detachably connected to the second part.

The collection tank 55 is formed on the first part. After the first part and the second part are detached and separated, the cleaning of the consumables 3 in the collection tank 55 is facilitated. After the first part and the second part are assembled together, a complete housing is formed, so that a certain sealing and protection effect can be provided for the parts in the housing to prevent external impurities from entering the housing.

A slideway is provided on an inner wall of the housing, and the pressure relief slider 432 is slidably arranged in the slideway. The slideway extends in a direction intersecting with the moving direction of the consumable 3, so as to limit the pressure relief slider 432 to move in the direction intersecting with the moving direction of the consumable 3.

The rotating member 512 includes a recessed section 5121 and a smooth section 5122. The recessed section 5121 and the smooth section 5122 are arranged in a circumferential direction of the rotating member 512. The recessed section 5121 is recessed inward in the radial direction of the rotating member 512, and the smooth section 5122 protrudes outward in the radial direction of the rotating member 512. The clamping unit 53 includes a first clamping member 531 and a second clamping member 532. The first clamping member 531 is arranged opposite the second clamping member 532. A first end of the first clamping member 531 is provided with a first groove, a first end of the second clamping member 532 is provided with a second groove, and the first groove is configured to be engaged with the second groove to form a clamping space 533. A second end of the first clamping member 531 is slidably arranged on an outer peripheral wall of the rotating member 512, and a second end of the second clamping member 532 is slidably arranged on the outer peripheral wall of the rotating member 512. The driving member 511 drives the rotating member 512 to rotate, and is configured to drive the second end of the first clamping member 531 and the second end of the second clamping member 532 to move toward or away from each other by means of the recessed section 5121 and the smooth section 5122, so as to clamp or release the consumable 3. Moving toward each other means approaching each other, and moving away from each other means being away from each other.

The recessed section 5121 and the smooth section 5122 are provided on the rotating member 512, and the first clamping member 531 and the second clamping member 532 are driven to move by the recessed section 5121 and the smooth section 5122, so as to clamp or release the consumable 3, so that the structure is simple and stable, and the reliability is high.

A middle portion of the first clamping member 531 is hinged to the mounting carrier, and a hinge point is located between the first end and the second end of the first clamping member 531. A middle portion of the second clamping member 532 is hinged to the mounting carrier, and a hinge point is located between the first end and the second end of the second clamping member 532. When the rotating member 512 rotates, during sliding of the second end of the first clamping member 531 and the second end of the second clamping member 532 from the recessed section 5121 to the smooth section 5122, a distance between the second end of the first clamping member 531 and the second end of the second clamping member 532 gradually increases. Since the middle portion of the first clamping member 531 is hinged to the mounting carrier and the middle portion of the second clamping member 532 is hinged to the mounting carrier, a distance between the first end of the first clamping member 531 and the first end of the second clamping member 532 gradually decreases until the first ends come into contact with each other, and thus the consumable 3 is clamped by means of the first groove and the second groove. When the rotating member 512 rotates, during sliding of the second end of the first clamping member 531 and the second end of the second clamping member 532 from the smooth section 5122 to the recessed section 5121, the distance between the second end of the first clamping member 531 and the second end of the second clamping member 532 gradually decreases. Since the middle portion of the first clamping member 531 is hinged to the mounting carrier and the middle portion of the second clamping member 532 is hinged to the mounting carrier, the first end of the first clamping member 531 and the first end of the second clamping member 532 are separated from each other, and the distance therebetween gradually increases, so that the consumable 3 is released.

Optionally, the first clamping member 531 and the second clamping member 532 have the same size, and the first clamping member 531 and the second clamping member 532 are arranged in a mirror symmetrical manner.

Optionally, the first clamping member 531 and the second clamping member 532 each are L-shaped, and the first end of the first clamping member 531 and the first end of the second clamping member 532 extend toward each other. When the first ends abut together, the first groove and the second groove are engaged opposite each other to form a circular clamping space 533.

Optionally, the first groove and the second groove are formed in the same size, and may be both semicircular, so as to form a regular clamping space 533. The cross-sectional area of the clamping space 533 may be equal to or slightly less than the cross-sectional area of the consumable 3 to ensure that the consumable 3 can be clamped. When the consumable 3 advances or retreats, the first clamping member 531 and the second clamping member 532 do not clamp the consumable 3.

Optionally, the second end of the first clamping member 531 and the second end of the second clamping member 532 keep abutting against the outer peripheral wall of the rotating member 512, to be fully connected to the outer peripheral wall, and can slide on the outer peripheral wall of the rotating member 512 when the rotating member 512 rotates.

The cutting apparatus further includes a mounting frame 54, the first clamping member 531 is rotatably connected to the mounting frame 54, and the second clamping member 532 is rotatably connected to the mounting frame 54. The cutting member 52 is arranged corresponding to the recessed section 5121. With the arrangement of the mounting frame 54, a stable mounting position is provided for the first clamping member 531 and the second clamping member 532, and it is ensured that the first clamping member 531 and the second clamping member 532 can rotate stably. The cutting member 52 is arranged corresponding to the recessed section 5121, so that the cutting member 52 can be linked with the first clamping member 531 and the second clamping member 532. When the cutting member 52 cuts the consumable 3, the first clamping member 531 and the second clamping member 532 clamp the consumable 3 to provide a support force for the consumable 3, so as to prevent the consumable 3 from moving with the cutting member 52, which otherwise results in that the consumable 3 cannot be effectively cut. After the cutting, the first clamping member 531 and the second clamping member 532 release the consumable 3, and then the cut consumption end is discharged out of the moving path of the consumable 3 to avoid blocking subsequent discharge of a consumable 3.

The cutting member 52 is arranged corresponding to the recessed section 5121, that is, the cutting member 52 and the recessed section 5121 are arranged opposite each other in an axial direction of the rotating member 512.

The mounting frame 54 is the mounting carrier described above, and the mounting frame 54 may be fixedly connected to the inner wall of the housing. The mounting frame 54 may be a one-piece apparatus, or the mounting frame 54 includes a plurality of mounting sub-frames 54, such that the first clamping member 531 and the second clamping member 532 are connected to the mounting frame 54.

A raised first spindle and a raised second spindle may be arranged on the mounting frame 54. The first clamping member 531 is rotatably connected to the mounting frame 54 via the first spindle, and the second clamping member 532 is rotatably connected to the mounting frame 54 via the second spindle. The first spindle is located between the first end and the second end of the first clamping member 531; and the second spindle is located between the first end and the second end of the second clamping member 532. With the arrangement of the first spindle and the second spindle, the first clamping member 531 and the second clamping member 532 are stably and rotatably connected to the mounting frame 54. In addition, when the first end of the first clamping member 531 and the first end of the second clamping member 532 move away from each other, the second end of the first clamping member 531 and the second end of the second clamping member 532 move toward each other. When the first end of the first clamping member 531 and the first end of the second clamping member 532 move toward each other, the second end of the first clamping member 531 and the second end of the second clamping member 532 move away from each other.

The first clamping member 531 and the second clamping member 532 are L-shaped. The first spindle may be arranged at a corner of the first clamping member 531, and the second spindle may be arranged at a corner of the second clamping member 532.

Optionally, an even number of recessed sections 5121 are provided, and an even number of smooth sections 5122 are provided. The recessed sections 5121 and the smooth sections 5122 are arranged spaced apart in a circumferential direction of the rotating member 512, and the recessed sections 5121 are arranged opposite to each other in the radial direction of the rotating member 512. The smooth sections 5122 are arranged opposite to each other in the radial direction of the rotating member 512. It can be ensured that the first clamping member 531 and the second clamping member 532 slide onto different smooth sections 5122 or recessed sections 5121 simultaneously, thereby ensuring that the first clamping member 531 and the second clamping member 532 move simultaneously to clamp or release the consumable 3. The driving member 511 drives the rotating member 512 and the cutting member 52 to rotate synchronously, and the cutting member 52 is arranged corresponding to the recessed section 5121, so that it is ensured that the consumable 3 is released after the consumable 3 is cut, and the consumable 3 is clamped before the consumable 3 is cut, thus ensuring the stability of linkage.

Optionally, in this implementation, two smooth sections 5122 are provided, two recessed sections 5121 are provided, the two smooth sections 5122 account for half of an outer circle of the rotating member 512, and the two recessed sections 5121 account for half of the outer circle of the rotating member 512. That is, each smooth section 5122 has a radian of x/2, and each recessed section 5121 has a radian of x/2.

The clamping unit 53 further includes an elastic tensioning unit 534. One end of the elastic tensioning unit 534 is arranged at the second end of the first clamping member 531, and the other end of the elastic tensioning unit 534 is arranged at the second end of the second clamping member 532. The elastic tensioning unit 534 applies an elastic force toward the rotating member 512 to first clamping member 531 and the second clamping member 532, such that the second end of the first clamping member 531 and the second end of the second clamping member 532 are attached to a circumferential outer wall of the rotating member 512. With the arrangement of the elastic tensioning unit 534, it is ensured that the second end of the first clamping member 531 and the second end of the second clamping member 532 can stably abut against the circumferential outer wall of the rotating member 512.

It can be understood that one end of the elastic tensioning unit 534 is arranged at the second end of the first clamping member 531, and the other end of the elastic tensioning unit 534 is arranged at the second end of the second clamping member 532. That is, the elastic tensioning unit 534 is closer to the second end of the first clamping member 531 than the first end thereof, and the elastic tensioning unit 534 is closer to the second end of the second clamping member 532 than the first end thereof.

Optionally, an elastic force applied by the elastic tensioning unit 534 to the second end of the first clamping member 531 and the second end of the second clamping member 532 is smaller than a thrust applied by the rotating member 512 to the second end of the first clamping member 531 and the second end of the second clamping member 532, such that the first clamping member 531 and the second clamping member 532 can be driven to move by the smooth sections 5122 of the rotating member 512.

Optionally, the elastic tensioning unit 534 is a spring.

In another aspect of this implementation, a printing consumable conveyor is provided, including a cutting apparatus as described above. The printing consumable conveyor further includes a discharging channel 2, and the cutting apparatus is arranged on the discharging channel 2. A channel pulley 56 is further arranged on the discharging channel 2. A cutting switch 57 is arranged on a side of the channel pulley 56 away from the discharging channel 2, and the cutting switch 57 is electrically connected to the controller. When the consumable 3 passes across the channel pulley 56, the consumable 3 pushes the channel pulley 56 to trigger the cutting switch 57 to send out a consumable passing signal. When the printing consumable conveyor is in a consumable return condition and after a consumption end of the consumable 3 passes across the channel pulley 56, the channel pulley 56 is separated from the cutting switch 57 to trigger the cutting switch 57 to be converted from a consumable passing signal to a consumable cutting signal, such that the controller controls the cutting apparatus to cut the consumable 3. With the arrangement of the channel pulley 56 and the cutting switch 57, based on the consumable passing signal sent by the cutting switch 57, the cutting apparatus ensures that the cutting apparatus cuts no consumable 3 during normal discharge by the printing consumable conveyor. When the cutting switch 57 is converted from a consumable passing signal to a consumable cutting signal, the cutting apparatus cuts the consumable 3, thus ensuring the stability of normal discharge and the accuracy of cutting.

Optionally, the channel pulley 56 is located above the consumable 3, and the cutting switch 57 is located above the channel pulley 56. When the consumable 3 is conveyed and discharged normally, the consumable 3 passes across the channel pulley 56 and pushes the channel pulley 56 upward, so that the channel pulley 56 touches and presses the cutting switch 57, and then the cutting switch 57 sends a consumable passing signal such that the cutting switch 57 controls the cutting apparatus not to operate, ensuring normal discharge. When the printing consumable conveyor is in a consumable return condition and after a consumption end of the consumable 3 passes across the channel pulley 56, the consumable 3 no longer applies a thrust to the channel pulley 56, the roller no longer applies a pressure to the cutting switch 57, and the roller can be separated from the cutting switch 57 under its own gravity and resilience of the cutting switch 57, thereby triggering the cutting switch 57 to be converted from a consumable passing signal to a consumable cutting signal. The cutting switch 57 controls the cutting apparatus to act immediately to cut the consumption end of the consumable 3.

A position of the discharging channel 2 corresponding to the channel pulley 56 is a set position, that is, a position of the channel pulley 56 in the discharging channel 2 is the set position.

The printing consumable conveyor further includes a base 6 and a cover plate 7. The base 6 and the cover plate 7 are arranged in a housing. A mounting frame 54 may be connected to the housing, or may be connected to the base 6 and the cover plate 7. An end of the first elastic member 422 away from the pressing plate 4212 is arranged on the cover plate 7, and the base 6 is connected to the cover plate 7. The feeding channels 1 and the discharging channel 2 are provided in a first wall surface of the base 6, and the cover plate 7 covers the first wall surface to close the feeding channels 1 and the discharging channel 2. The cover plate 7 is provided with mounting holes 71, and the base 6 is provided with a mounting groove 61, such that the pushing apparatus drives a consumable in at least one of the feeding channels to pass through the discharging channel to advance, or drives a consumable 3 in at least one of the feeding channels 1 to retreat. The pressing roller 4211 can pass through the mounting hole 71 to clamp the consumable, and the power wheel 411 is arranged in the mounting groove 61. The mounting holes 71 are through holes. A plurality of mounting holes 71 correspond to the mounting groove 61.

The base 6 provides arrangement positions for the feeding channels 1 and the discharging channel 2, and the cover plate 7 and the base 6 provide mounting positions for the mounting frame 54 and the first elastic member 422, thus ensuring the structural stability of the printing consumable conveyor.

The base 6 is further provided with a clearance portion 62, and the cutting apparatus is fixed to the clearance portion 62. The mounting frame 54 may be fixedly connected to the clearance portion 62. The feeding channels and the discharging channel are formed in the base 6 and the cover plate 7, and a mounting position is provided for the cutting apparatus.

In another aspect of this implementation, a 3D printer is provided, including a printing consumable conveyor described above.

### Embodiment

As shown in FIGS. 1 to 26, this embodiment provides a printing consumable conveyor, including a discharging channel 2, at least two feeding channels 1, a pushing apparatus, and a cutting apparatus. The at least two feeding channels 1 are each in communication with the discharging channel 2, and the pushing apparatus is arranged on the feeding channels 1. The pushing apparatus is configured to drive a consumable 3 in at least one of the feeding channels 1 to pass through the discharging channel 2 to advance, or to drive a consumable 3 in at least one of the feeding channels 1 to retreat. The cutting apparatus is disposed on the discharging channel 2, and the cutting apparatus is configured to cut the consumable 3 when the pushing apparatus drives the consumable 3 to retreat to a set position.

The pushing apparatus includes a power member 41, a pressing apparatus 42, and a pressure relief apparatus 43. A consumable 3 is located between the power member 41 and the pressing apparatus 42, and the pressing apparatus 42 is configured to clamp the consumable 3 with the power member 41 under the action of an external force. The power member 41 is configured to drive the clamped consumable 3 to move, and the pressure relief apparatus 43 is connected to the pressing apparatus 42. When a pressure of the pressing apparatus 42 on the consumable 3 is greater than a preset value, the pressure relief apparatus 43 is configured to move the pressing apparatus 42 in a direction away from the power member 41.

The pressing apparatus 42 includes a pressing member and a first elastic member 422. A consumable 3 is located between the power member 41 and the pressing member, and the first elastic member 422 is arranged on a side of the pressing member close to the power member 41. The pressing member is connected to the pressure relief apparatus 43, and when the pressing member moves toward the power member 41, the first elastic member 422 applies, to the pressing member, an elastic force for causing the pressing member to move away from the power member 41. The pressing member includes a pressing roller 4211 and a pressing plate 4212. The pressing roller 4211 is arranged on the pressing plate 4212. The pressing roller 4211 is arranged opposite the power member 41, and the consumable 3 is located between the power member 41 and the pressing roller 4211. The pressing plate 4212 includes a first end and a second end. The pressure relief apparatus 43 is arranged at the second end, and the first end of the pressing plate 4212 causes the pressing roller 4211 and the power member 41 to clamp the consumable 3 under the action of an external force. The pushing apparatus further includes a connecting shaft. The connecting shaft runs through the pressing plate 4212, and the connecting shaft is connected to the pressure relief apparatus 43. At least two pressing apparatuses 42 are provided, and the number of consumables 3 corresponds to the number of pressing apparatuses 42. The pressing apparatuses 42 are arranged corresponding to the consumables 3. The at least two pressing apparatuses 42 are connected to the pressure relief apparatus 43, and the pressing apparatuses 42 can selectively come into contact with the consumable 3, such that the power member 41 and the selected pressing apparatus 42 clamp the consumable 3.

The pressure relief apparatus 43 includes a second elastic member 431 and a pressure relief slider 432. The pressure relief slider 432 is connected to the pressing member and the second elastic member 431. The pressure relief slider 432 is arranged on a side of the second elastic member 431 facing the power member 41. The pressure relief slider 432 is limited to move in a direction intersecting with a moving direction of the consumable 3, and the second elastic member 431 applies, to the pressing member by the pressure relief slider 432, an elastic force toward a side where the power member 41 is located.

The pushing apparatus further includes a pushing member 44. The pushing member 44 is arranged on a side of the pressing plate 4212 away from the pressing roller 4211. The pushing member 44 and the first elastic member 422 are arranged at the first end of the pressing plate 4212, and the pushing member 44 can selectively drive a pressing apparatus 42 to move, such that the pressing apparatus 42 and the power member 41 clamp the consumable 3 or that the consumable 3 is separated from the pressing apparatus 42. The pushing member 44 includes a plurality of cams 441. The cams 441 are arranged corresponding to the pressing plates 4212. When rotating to a set rotation position, the cams 441 can drive the corresponding pressing plates 4212 to cooperate with the power member 41 to clamp the consumable 3. The pushing apparatus further includes a rotating unit 45. The rotating unit 45 includes a driving shaft 451. The cams 441 are arranged on the driving shaft 451, and the cams 441 are arranged in an axial direction of the driving shaft 451 and rotate synchronously. Protrusions of the plurality of cams 441 are sequentially staggered by a preset angle in a rotation direction of the driving shaft 451. The driving shaft 451 includes a first end and a second end. Among the plurality of cams 441 on the driving shaft 451, a cam 441 closest to the first end is a first cam, a cam 441 closest to the second end is a second cam, and a minimum angle between the first cam and the second cam in the rotation direction of the driving shaft 451 is greater than the preset angle.

The printing consumable conveyor further includes a controller, and the cutting apparatus includes a driving unit and a cutting member 52. The controller is electrically connected to the driving unit to send a control instruction to the driving unit, and the driving unit is connected to the cutting member 52 to drive the cutting member 52 to move based on the control instruction to cut a consumable 3.

The driving unit is specifically configured to drive, during replacement of a consumable 3 used by a 3D printer, the cutting member 52 to cut an end of the consumable 3 when the consumable 3 retreats for a preset time or retreats to a preset position. The cutting apparatus further includes a clamping unit 53. During cutting of the consumable 3, the driving unit is configured to drive the clamping unit 53 to clamp the consumable 3 and drive the cutting member 52 to act to cut the consumable 3, and after the consumable 3 is cut, the driving unit is configured to drive the clamping unit 53 to release the consumable 3 and drive the cutting member 52 away from the consumable 3. The driving unit includes a driving member 511 and a rotating member 512. The driving member 511 is connected to the rotating member 512 and is configured to drive the rotating member 512 to rotate. The cutting member 52 is connected to the rotating member 512, such that the cutting member 52 rotates with the rotating member 512, and a blade end of the cutting member 52 protrudes from the rotating member 512 in a radial direction of the rotating member 512. The rotating member 512 includes a recessed section 5121 and a smooth section 5122. The recessed section 5121 and the smooth section 5122 are arranged in a circumferential direction of the rotating member 512. The recessed section 5121 is recessed inward in the radial direction of the rotating member 512, and the smooth section 5122 protrudes outward in the radial direction of the rotating member 512.

The cutting member 52 is located on one side of the clamping unit 53. The clamping unit 53 includes a first clamping member 531 and a second clamping member 532. The first clamping member 531 is arranged opposite the second clamping member 532. A first end of the first clamping member 531 is provided with a first groove, a first end of the second clamping member 532 is provided with a second groove, and the first groove is configured to be engaged with the second groove to form a clamping space 533. A second end of the first clamping member 531 is slidably arranged on an outer peripheral wall of the rotating member 512, and a second end of the second clamping member 532 is slidably arranged on the outer peripheral wall of the rotating member 512. The driving member 511 drives the rotating member 512 to rotate, and is configured to drive the second end of the first clamping member 531 and the second end of the second clamping member 532 to move toward or away from each other by means of the recessed section 5121 and the smooth section 5122, so as to clamp or release the consumable 3. The cutting apparatus further includes a mounting frame 54, the first clamping member 531 is rotatably connected to the mounting frame 54, and the second clamping member 532 is rotatably connected to the mounting frame 54. The cutting member 52 is arranged corresponding to the recessed section 5121.

The clamping unit 53 further includes an elastic tensioning unit 534. One end of the elastic tensioning unit 534 is arranged at the second end of the first clamping member 531, and the other end of the elastic tensioning unit 534 is arranged at the second end of the second clamping member 532. The elastic tensioning unit 534 applies an elastic force toward the rotating member 512 to first clamping member 531 and the second clamping member 532, such that the second end of the first clamping member 531 and the second end of the second clamping member 532 are attached to a circumferential outer wall of the rotating member 512. A raised first spindle and a raised second spindle are arranged on the mounting frame 54. The first clamping member 531 is rotatably connected to the mounting frame 54 via the first spindle, and the second clamping member 532 is rotatably connected to the mounting frame 54 via the second spindle. The first spindle is located between the first end and the second end of the first clamping member 531; and the second spindle is located between the first end and the second end of the second clamping member 532. An even number of recessed sections 5121 are provided, and an even number of smooth sections 5122 are provided. The recessed sections 5121 and the smooth sections 5122 are arranged spaced apart in a circumferential direction of the rotating member 512, and the recessed sections 5121 are arranged opposite to each other in the radial direction of the rotating member 512. The smooth sections 5122 are arranged opposite to each other in the radial direction of the rotating member 512. The printing consumable conveyor includes a housing, and the cutting apparatus and the pushing apparatus may be arranged in the housing. The housing includes a collection tank 55, and an opening of the collection tank 55 is arranged opposite the clamping unit 53.

A channel pulley 56 is arranged on the discharging channel 2. A cutting switch 57 is arranged on a side of the channel pulley 56 away from the discharging channel 2, and the cutting switch 57 is electrically connected to the controller. When the consumable 3 passes across the channel pulley 56, the consumable 3 pushes the channel pulley 56 to trigger the cutting switch 57 to send out a consumable passing signal. When the printing consumable conveyor is in a consumable return condition and after a consumption end of the consumable 3 passes across the channel pulley 56, the channel pulley 56 is separated from the cutting switch 57 to trigger the cutting switch 57 to be converted from a consumable passing signal to a consumable cutting signal, such that the controller controls the cutting apparatus to cut the consumable 3.

In another aspect of this embodiment, a 3D printer is provided, including a printing consumable conveyor described above.

It will be readily appreciated by those skilled in the art that the aforementioned advantageous ways can be freely combined and superimposed without conflict.

The above embodiments are merely preferred embodiments of the present application but not intended to limit the present application, and any modifications, equivalent replacements, improvements, etc. made within the spirit and principle of the present application should be included within the scope of protection of the present application. The above are only preferred implementations of the present application, and it should be noted that for those of ordinary skill in the art, several improvements and variations may also be made without departing from the technical principle of the present application, and these improvements and variations should be also considered to be within the scope of protection of the present application.

What is claimed is:

1. A printing consumable conveyor, comprising a discharging channel, at least two feeding channels, a pushing apparatus, and a cutting apparatus, wherein the at least two feeding channels are each in communication with the discharging channel, the pushing apparatus is arranged on the at least two feeding channels, the pushing apparatus is configured to drive a consumable in at least one of the at least two feeding channels to pass through the discharging channel to advance, or to drive the consumable in at least one of the at least two feeding channels to retreat, the cutting apparatus is disposed on the discharging channel, and the cutting apparatus is configured to cut the consumable when the pushing apparatus drives the consumable to retreat to a predetermined position.

2. The printing consumable conveyor according to claim 1, wherein the pushing apparatus comprises a power member, a pressing apparatus, and a pressure relief apparatus, wherein the consumable in one of the at least two feeding channels is located between the power member and the pressing apparatus, the pressing apparatus is configured to clamp the consumable with the power member under an action of an external force, the power member is configured to drive the consumable to move, the pressure relief apparatus is connected to the pressing apparatus, and when a pressure of the pressing apparatus on the consumable is greater than a preset value, the pressure relief apparatus is configured to move the pressing apparatus in a direction away from the power member.

3. The printing consumable conveyor according to claim 2, wherein the pressing apparatus comprises a pressing member and a first elastic member, wherein the consumable in one of the at least two feeding channels is located between the power member and the pressing member, the first elastic member is arranged on a side of the pressing member adjacent to the power member, the pressing member is connected to the pressure relief apparatus, and when the pressing member moves toward the power member, the first elastic member applies, to the pressing member, an elastic force for allowing the pressing member to move away from the power member;
the pressing member comprises a pressing roller and a pressing plate, wherein the pressing roller is arranged on the pressing plate, the pressing roller is arranged opposite to the power member, and the consumable is located between the power member and the pressing roller;
the pressing plate comprises a first end and a second end, wherein the pressure relief apparatus is arranged at the second end, and the first end of the pressing plate allows the pressing roller and the power member to clamp the consumable under the action of the external force;
the pushing apparatus further comprises a connecting shaft, wherein the connecting shaft runs through the pressing plate, and the connecting shaft is connected to the pressure relief apparatus; and
at least two pressing apparatuses are provided, a number of consumables corresponds to a number of the at least two pressing apparatuses, the at least two pressing apparatuses are arranged corresponding to the consumables, the at least two pressing apparatuses are connected to the pressure relief apparatus, and the at least two pressing apparatuses are configured to selectively come into contact with the consumable, such that the power member and a pressing apparatus selected from the at least two pressing apparatuses clamp the consumable.

4. The printing consumable conveyor according to claim 2, wherein the pressure relief apparatus comprises a second elastic member and a pressure relief slider, wherein the pressure relief slider is connected to the pressing apparatus and the second elastic member, the pressure relief slider is arranged on a side of the second elastic member facing the power member, the pressure relief slider is limited to move in a direction intersecting with a moving direction of the consumable, and the second elastic member applies, to the pressing apparatus by the pressure relief slider, an elastic force toward a side where the power member is located.

5. The printing consumable conveyor according to claim 3, wherein the pushing apparatus further comprises a pushing member, wherein the pushing member is arranged on a side of the pressing plate away from the pressing roller, the pushing member and the first elastic member are arranged at the first end of the pressing plate, and the pushing member is configured to selectively drive the pressing apparatus to move, such that the pressing apparatus and the power member clamp the consumable or that the consumable is separated from the pressing apparatus;
the pushing member comprises a plurality of cams, wherein the plurality of cams are arranged corresponding to pressing plates, and when rotating to a predetermined rotation position, each cam of the plurality of cams is configured to drive the pressing plate corresponding to each cam to cooperate with the power member to clamp the consumable;
the pushing apparatus further comprises a rotating unit, and the rotating unit comprises a driving shaft, wherein the plurality of cams are arranged on the driving shaft, the plurality of cams are arranged in an axial direction of the driving shaft and rotate synchronously, and protrusions of the plurality of cams are sequentially staggered by a preset angle in a rotation direction of the driving shaft; and
the driving shaft comprises a first end and a second end; and among the plurality of cams on the driving shaft, a cam closest to the first end is a first cam, a cam closest to the second end is a second cam, and a minimum angle between the first cam and the second cam in the rotation direction of the driving shaft is greater than the preset angle.

6. The printing consumable conveyor according to claim 1, further comprising a controller, wherein the cutting apparatus comprises a driving unit and a cutting member, the controller is electrically connected to the driving unit to send a control instruction to the driving unit, and the driving unit is connected to the cutting member to drive the cutting member to move based on the control instruction to cut the consumable.

7. The printing consumable conveyor according to claim 6, wherein the driving unit is configured to drive, during replacement of the consumable used by a 3D printer, the cutting member to cut an end of the consumable when the consumable retreats for a preset time or retreats to a preset position;
the cutting apparatus further comprises a clamping unit; during cutting of the consumable, the driving unit is configured to drive the clamping unit to clamp the consumable and drive the cutting member to act to cut the consumable, and after the consumable is cut, the driving unit is configured to drive the clamping unit to release the consumable and drive the cutting member to move away from the consumable;
the driving unit comprises a driving member and a rotating member, wherein the driving member is connected to the rotating member and is configured to drive the rotating member to rotate, the cutting member is connected to the rotating member such that the cutting member rotates with the rotating member, and a blade end of the cutting member protrudes from the rotating member in a radial direction of the rotating member;
the rotating member comprises a recessed section and a smooth section, wherein the recessed section and the smooth section are arranged in a circumferential direction of the rotating member, the recessed section is recessed inward in the radial direction of the rotating member, and the smooth section protrudes outward in the radial direction of the rotating member;
the cutting member is located on a side of the clamping unit, the clamping unit comprises a first clamping member and a second clamping member, the first clamping member is arranged opposite to the second clamping member, a first end of the first clamping member is provided with a first groove, a first end of the second clamping member is provided with a second groove, and the first groove is configured to be engaged with the second groove to form a clamping space;
a second end of the first clamping member is slidably arranged on an outer peripheral wall of the rotating member, a second end of the second clamping member is slidably arranged on the outer peripheral wall of the rotating member, the driving member drives the rotating member to rotate, and the driving member is configured to drive the second end of the first clamping member and the second end of the second clamping member to move toward or away from each other by the recessed section and the smooth section, so as to clamp or release the consumable;
the cutting apparatus further comprises a mounting frame, wherein the first clamping member is rotatably connected to the mounting frame, and the second clamping member is rotatably connected to the mounting frame; and
the cutting member is arranged corresponding to the recessed section.

8. The printing consumable conveyor according to claim 7, wherein the clamping unit further comprises an elastic tensioning unit, wherein a first end of the elastic tensioning unit is arranged at the second end of the first clamping member, a second end of the elastic tensioning unit is arranged at the second end of the second clamping member, and the elastic tensioning unit applies an elastic force toward the rotating member to the first clamping member and the second clamping member, such that the second end of the first clamping member and the second end of the second clamping member are attached to the outer peripheral wall of the rotating member;
a raised first spindle and a raised second spindle are arranged on the mounting frame;
the first clamping member is rotatably connected to the mounting frame via the raised first spindle, and the second clamping member is rotatably connected to the mounting frame via the raised second spindle;
the raised first spindle is located between the first end and the second end of the first clamping member;
the raised second spindle is located between the first end and the second end of the second clamping member;
an even number of recessed sections are arranged, an even number of smooth sections are arranged, the recessed sections and the smooth sections are spaced apart in a circumferential direction of the rotating member, the recessed sections are arranged opposite to each other in the radial direction of the rotating member, and the smooth sections are arranged opposite to each other in the radial direction of the rotating member;
the printing consumable conveyor comprises a housing, wherein the cutting apparatus and the pushing apparatus are arranged in the housing, the housing comprises a collection tank, and an opening of the collection tank is arranged opposite to the clamping unit; and
the printing consumable conveyor further comprises a base and a cover plate, wherein the base and the cover plate are arranged in the housing, the mounting frame is connected to the base, the base is connected to the cover plate, the at least two feeding channels and the discharging channel are provided in a wall surface of the base, the cover plate covers the wall surface to close the at least two feeding channels and the discharging channel, the cover plate is provided with a mounting hole, the base is provided with a mounting groove, such that the pushing apparatus drives the consumable in at least one of the at least two feeding channels to pass through the discharging channel to advance, the mounting hole corresponds to the mounting groove, the base is provided with a clearance portion, and the cutting apparatus is arranged on the clearance portion.

9. The printing consumable conveyor according to claim 7, wherein a channel pulley is arranged on the discharging channel, a cutting switch is arranged on a side of the channel pulley away from the discharging channel, and the cutting switch is electrically connected to the controller;
when the consumable passes across the channel pulley, the consumable pushes the channel pulley to trigger the cutting switch to send out a consumable passing signal; and
when the printing consumable conveyor is in a consumable return condition and after a consumption end of the consumable passes across the channel pulley, the channel pulley is separated from the cutting switch to trigger the cutting switch to be converted from the consumable passing signal to a consumable cutting signal, such that the controller controls the cutting apparatus to cut the consumable.

10. A 3D printer, comprising the printing consumable conveyor according to claim 1.

11. The 3D printer according to claim 10, wherein in the printing consumable conveyor, the pushing apparatus comprises a power member, a pressing apparatus, and a pressure relief apparatus, wherein the consumable in one of the at least two feeding channels is located between the power member and the pressing apparatus, the pressing apparatus is configured to clamp the consumable with the power member under an action of an external force, the power member is configured to drive the consumable to move, the pressure relief apparatus is connected to the pressing apparatus, and when a pressure of the pressing apparatus on the consumable is greater than a preset value, the pressure relief apparatus is configured to move the pressing apparatus in a direction away from the power member.

12. The 3D printer according to claim 11, wherein in the printing consumable conveyor, the pressing apparatus comprises a pressing member and a first elastic member, wherein the consumable in one of the at least two feeding channels is located between the power member and the pressing member, the first elastic member is arranged on a side of the pressing member adjacent to the power member, the pressing member is connected to the pressure relief apparatus, and when the pressing member moves toward the power member, the first elastic member applies, to the pressing member, an elastic force for allowing the pressing member to move away from the power member;
the pressing member comprises a pressing roller and a pressing plate, wherein the pressing roller is arranged on the pressing plate, the pressing roller is arranged opposite to the power member, and the consumable is located between the power member and the pressing roller;
the pressing plate comprises a first end and a second end, wherein the pressure relief apparatus is arranged at the second end, and the first end of the pressing plate allows the pressing roller and the power member to clamp the consumable under the action of the external force;
the pushing apparatus further comprises a connecting shaft, wherein the connecting shaft runs through the pressing plate, and the connecting shaft is connected to the pressure relief apparatus; and
at least two pressing apparatuses are provided, a number of consumables corresponds to a number of the at least two pressing apparatuses, the at least two pressing apparatuses are arranged corresponding to the consumables, the at least two pressing apparatuses are connected to the pressure relief apparatus, and the at least two pressing apparatuses are configured to selectively come into contact with the consumable, such that the power member and a pressing apparatus selected from the at least two pressing apparatuses clamp the consumable.

13. The 3D printer according to claim 11, wherein in the printing consumable conveyor, the pressure relief apparatus comprises a second elastic member and a pressure relief slider, wherein the pressure relief slider is connected to the pressing apparatus and the second elastic member, the pressure relief slider is arranged on a side of the second elastic member facing the power member, the pressure relief slider is limited to move in a direction intersecting with a moving direction of the consumable, and the second elastic member applies, to the pressing apparatus by the pressure relief slider, an elastic force toward a side where the power member is located.

14. The 3D printer according to claim 12, wherein in the printing consumable conveyor, the pushing apparatus further comprises a pushing member, wherein the pushing member is arranged on a side of the pressing plate away from the pressing roller, the pushing member and the first elastic member are arranged at the first end of the pressing plate, and the pushing member is configured to selectively drive the pressing apparatus to move, such that the pressing apparatus and the power member clamp the consumable or that the consumable is separated from the pressing apparatus;
the pushing member comprises a plurality of cams, wherein the plurality of cams are arranged corresponding to pressing plates, and when rotating to a predetermined rotation position, each cam of the plurality of cams is configured to drive the pressing plate corresponding to each cam to cooperate with the power member to clamp the consumable;
the pushing apparatus further comprises a rotating unit, and the rotating unit comprises a driving shaft, wherein the plurality of cams are arranged on the driving shaft, the plurality of cams are arranged in an axial direction of the driving shaft and rotate synchronously, and protrusions of the plurality of cams are sequentially staggered by a preset angle in a rotation direction of the driving shaft; and
the driving shaft comprises a first end and a second end; and among the plurality of cams on the driving shaft, a cam closest to the first end is a first cam, a cam closest to the second end is a second cam, and a minimum angle between the first cam and the second cam in the rotation direction of the driving shaft is greater than the preset angle.

15. The 3D printer according to claim 10, wherein the printing consumable conveyor further comprises a controller, wherein the cutting apparatus comprises a driving unit and a cutting member, the controller is electrically connected to the driving unit to send a control instruction to the driving unit, and the driving unit is connected to the cutting member to drive the cutting member to move based on the control instruction to cut the consumable.

16. The 3D printer according to claim 15, wherein in the printing consumable conveyor, the driving unit is configured to drive, during replacement of the consumable used by the 3D printer, the cutting member to cut an end of the consumable when the consumable retreats for a preset time or retreats to a preset position;
the cutting apparatus further comprises a clamping unit; during cutting of the consumable, the driving unit is configured to drive the clamping unit to clamp the consumable and drive the cutting member to act to cut the consumable, and after the consumable is cut, the driving unit is configured to drive the clamping unit to release the consumable and drive the cutting member to move away from the consumable;
the driving unit comprises a driving member and a rotating member, wherein the driving member is connected to the rotating member and is configured to drive the rotating member to rotate, the cutting member is connected to the rotating member such that the cutting member rotates with the rotating member, and a blade end of the cutting member protrudes from the rotating member in a radial direction of the rotating member;
the rotating member comprises a recessed section and a smooth section, wherein the recessed section and the smooth section are arranged in a circumferential direction of the rotating member, the recessed section is recessed inward in the radial direction of the rotating member, and the smooth section protrudes outward in the radial direction of the rotating member;
the cutting member is located on a side of the clamping unit, the clamping unit comprises a first clamping member and a second clamping member, the first clamping member is arranged opposite to the second clamping member, a first end of the first clamping member is provided with a first groove, a first end of the second clamping member is provided with a second groove, and the first groove is configured to be engaged with the second groove to form a clamping space;
a second end of the first clamping member is slidably arranged on an outer peripheral wall of the rotating member, a second end of the second clamping member is slidably arranged on the outer peripheral wall of the rotating member, the driving member drives the rotating member to rotate, and the driving member is configured to drive the second end of the first clamping member and the second end of the second clamping member to move toward or away from each other by the recessed section and the smooth section, so as to clamp or release the consumable;
the cutting apparatus further comprises a mounting frame, wherein the first clamping member is rotatably connected to the mounting frame, and the second clamping member is rotatably connected to the mounting frame; and
the cutting member is arranged corresponding to the recessed section.

17. The 3D printer according to claim 16, wherein in the printing consumable conveyor, the clamping unit further comprises an elastic tensioning unit, wherein a first end of the elastic tensioning unit is arranged at the second end of the first clamping member, a second end of the elastic tensioning unit is arranged at the second end of the second clamping member, and the elastic tensioning unit applies an elastic force toward the rotating member to the first clamping member and the second clamping member, such that the second end of the first clamping member and the second end of the second clamping member are attached to the outer peripheral wall of the rotating member;
a raised first spindle and a raised second spindle are arranged on the mounting frame; the first clamping member is rotatably connected to the mounting frame via the raised first spindle, and the second clamping member is rotatably connected to the mounting frame via the raised second spindle;
the raised first spindle is located between the first end and the second end of the first clamping member;
the raised second spindle is located between the first end and the second end of the second clamping member;
an even number of recessed sections are arranged, an even number of smooth sections are arranged, the recessed sections and the smooth sections are spaced apart in a circumferential direction of the rotating member, the recessed sections are arranged opposite to each other in the radial direction of the rotating member, and the smooth sections are arranged opposite to each other in the radial direction of the rotating member;
the printing consumable conveyor comprises a housing, wherein the cutting apparatus and the pushing apparatus are arranged in the housing, the housing comprises a collection tank, and an opening of the collection tank is arranged opposite to the clamping unit; and
the printing consumable conveyor further comprises a base and a cover plate, wherein the base and the cover plate are arranged in the housing, the mounting frame is connected to the base, the base is connected to the cover plate, the at least two feeding channels and the discharging channel are provided in a wall surface of the base, the cover plate covers the wall surface to close the at least two feeding channels and the discharging channel, the cover plate is provided with a mounting hole, the base is provided with a mounting groove, such that the pushing apparatus drives the consumable in at least one of the at least two feeding channels to pass through the discharging channel to advance, the mounting hole corresponds to the mounting groove, the base is provided with a clearance portion, and the cutting apparatus is arranged on the clearance portion.

18. The 3D printer according to claim 16, wherein in the printing consumable conveyor, a channel pulley is arranged on the discharging channel, a cutting switch is arranged on a side of the channel pulley away from the discharging channel, and the cutting switch is electrically connected to the controller;
when the consumable passes across the channel pulley, the consumable pushes the channel pulley to trigger the cutting switch to send out a consumable passing signal; and
when the printing consumable conveyor is in a consumable return condition and after a consumption end of the consumable passes across the channel pulley, the channel pulley is separated from the cutting switch to trigger the cutting switch to be converted from the consumable passing signal to a consumable cutting signal, such that the controller controls the cutting apparatus to cut the consumable.
